(19) United States
(12) Patent Application Publication
(10) Pub. No.: US 2024/0385986 A1
(43) Pub. Date: Nov. 21, 2024

(54) COMMUNICATION SYSTEM, COMPUTER, COMMUNICATION METHOD AND PROGRAM

(71) Applicant: Nippon Telegraph and Telephone Corporation, Tokyo (JP)

(72) Inventors: Tomoya HIBI, Musashino-shi, Tokyo (JP); Junki ICHIKAWA, Musashino-shi, Tokyo (JP); Yukio TSUKISHIMA, Musashino-shi, Tokyo (JP); Kenji SHIMIZU, Musashino-shi, Tokyo (JP); Hideki NISHIZAWA, Musashino-shi, Tokyo (JP); Kiwami INOUE, Musashino-shi, Tokyo (JP); Toru MANO, Musashino-shi, Tokyo (JP)

(21) Appl. No.: 18/687,875

(22) PCT Filed: Sep. 2, 2021
(86) PCT No.: PCT/JP2021/032313

§ 371 Date: Feb. 29, 2024

(51) Int. Cl. G06F 15/173; G06F 21/60

(52) U.S. Cl. CPC G06F 15/17331; G06F 21/606

(57) ABSTRACT

A communication system includes a plurality of computing machines connected to an optical network, in which the optical network includes a main signal communication path and a control communication path. Each of the computing machines and includes an RDMA communication unit that performs transmission of setting information for setting the main signal communication path to a computing machine of an access destination via the control communication path; and a main signal transmitting/receiving unit that establishes the main signal communication path based on the setting information. The RDMA communication unit gives an instruction for setting of the RDMA communication path in parallel with the transmission of the setting information. The computing machine further includes an RDMA control unit that secures a memory area for RDMA communication and transmits setting information including the memory area to the computing machine of the access destination.

### TECHNICAL FIELD

The present invention relates to a communication system, a computing machine, a communication method, and a program.

### BACKGROUND ART

In data communication between computing systems having a relatively short communication distance therebetween in a data center or the like, a remote direct memory access (RDMA) technology is used in which data is transferred between computing machines by accessing a memory without involving a CPU in order to increase a communication processing speed (Non-Patent Literature 1). Since direct connection of the computing machines to an optical network by an optical waveguide results in having no effect of a signal loss on a relay node, RDMA can be applied to long-distance data communication.

In optical communication, with the spread of 5G, a distributed control method and a centralized control method for dynamically setting or cancelling an optical communication path in response to various communication requests generated between geographically distributed computing machines have been studied (Non Patent Literatures 2 and 3).

### CITATION LIST

### Non-Patent Literature

Non-Patent Literature 1: IETF, “A Remote Direct Memory Access Protocol Specification”, RFC5040, October 2007.

Non-Patent Literature 2: Atsuko Takefusa, An Experiment of Co-allocating Computing and Lambda Path Resources on the Grid, IPSJ SIG Technical Reports 2006-ARC-167 2006-HPC-105.

Non-Patent Literature 3: Masahiko Jinno, “Photonic Transport Network Architecture to seigyo kanri gijutsu (in Japanese) (Photonic Transport Network Architecture and Control Management Technology)”, NTT Technical Review, October 2007.

### SUMMARY OF INVENTION

### Technical Problem

In a computing system connected via an optical network, when data transfer setting is performed by RDMA, a communication path is established for each layer in order from a lower layer to an upper layer in a general communication method.

When RDMA communication is started, first, a main signal communication path of a layer 1 of the lowest layer is established, and then an RDMA communication path of an upper layer is established. Although about several minutes are required to set the main signal communication path of the layer 1, the RDMA communication path is set after completion of the setting of the layer 1.

Therefore, when the main signal communication path and the RDMA communication path are dynamically established in response to a request from a user, it is a problem that it takes time before the RDMA communication becomes possible.

The present invention has been made in view of the above circumstances, and an object of the present invention is to shorten a time required to start RDMA communication.

### Solution to Problem

In order to achieve the above-described object, according to an aspect of the present invention, there is provided a communication system including: a plurality of computing machines connected to an optical network. The optical network includes a main signal communication path and a control communication path. Each computing machine includes a communication unit that performs transmission of setting information for setting the main signal communication path to a computing machine of an access destination via the control communication path, and a main signal transmitting/receiving unit that establishes the main signal communication path based on the setting information. The communication unit gives an instruction for setting of a remote direct memory access (RDMA) communication path in parallel with the transmission of the setting information. The computing machine further includes a control unit that secures a memory area for RDMA communication based on the instruction and transmits setting information including the memory area to the computing machine of the access destination via the control communication path to set the RDMA communication path.

According to another aspect of the present invention, there is provided a computing machine connected to a computing machine of an access destination via an optical network, in which the optical network includes a main signal communication path and a control communication path, the computing machine including: a communication unit that performs transmission of setting information for setting the main signal communication path to the computing machine of the access destination via the control communication path; and a main signal transmitting/receiving unit that establishes the main signal communication path based on the setting information. The communication unit gives an instruction for setting of a remote direct memory access (RDMA) communication path in parallel with the transmission of the setting information, and the computing machine further includes a control unit that secures a memory area for RDMA communication based on the instruction and transmits setting information including the memory area to the computing machine of the access destination via the control communication path to set the RDMA communication path.

According to another aspect of the present invention, there is provided a communication method performed by a communication system including a plurality of computing machines connected to an optical network. The optical network includes a main signal communication path and a control communication path. Each computing machine performs a step of transmitting setting information for setting the main signal communication path to a computing machine an access destination via the control communication path, a step of establishing the main signal communication path based on the setting information, and a step of securing a memory area for remote direct memory access (RDMA) communication and transmitting setting information including the memory area to the computing machine of the access destination via the control communication path to set the RDMA communication path, in parallel with the transmitting of the setting information.

According to another aspect of the present invention, there is provided a program for causing a computer to function as the above-described computing machine.

### Advantageous Effects of Invention

According to the present invention, a time required to start the RDMA communication can be shortened.

### BRIEF DESCRIPTION OF DRAWINGS

FIG. 1 is a diagram illustrating a configuration of a communication system according to an embodiment of the present invention.

FIG. 2 is an explanatory diagram for explaining a setting process of a communication path according to a comparative example.

FIG. 3 is an explanatory diagram for explaining a setting process of a communication path according to the embodiment.

FIG. 4 is a sequence diagram illustrating a setting process of the communication path according to the embodiment.

FIG. 5 is an explanatory diagram for explaining messages of S14 and S17 in FIG. 4.

FIG. 6 is a sequence diagram illustrating details of S31 and S32 in FIG. 4.

FIG. 7 is a sequence diagram illustrating the setting process of the communication path according to the comparative example of FIG. 2.

FIG. 8 illustrates an example of a hardware configuration.

### DESCRIPTION OF EMBODIMENTS

Hereinafter, embodiments of the present invention will be described with reference to the drawings.

### Configuration of Communication System

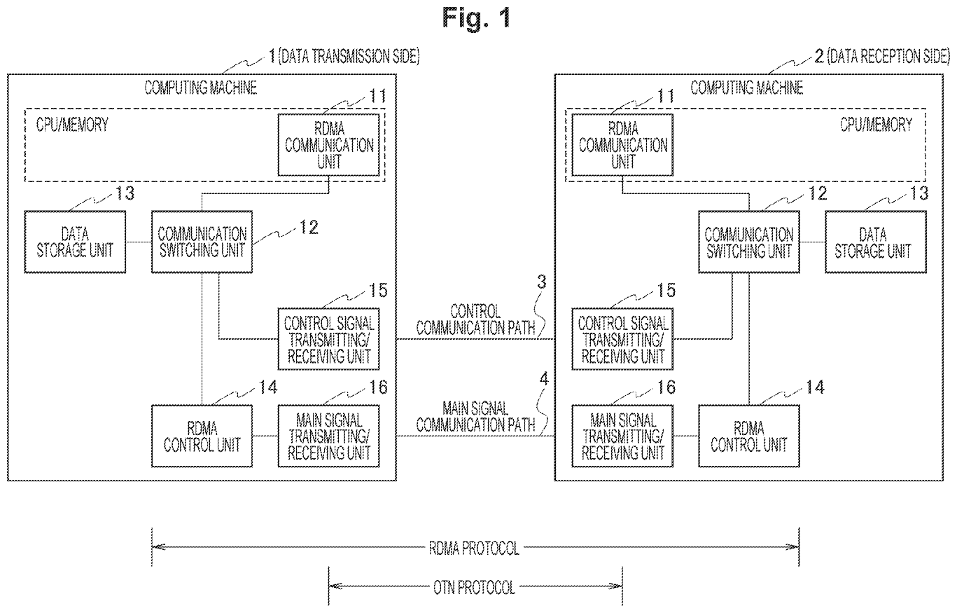

FIG. 1 is a system configuration diagram illustrating a communication system according to an embodiment of the present invention. The communication system of the embodiment includes a plurality of computing machines 1 and 2 connected to an optical network (optical transfer line).

The optical network includes a control communication path 3 and a main signal communication path 4. The control communication path 3 is a communication path for transferring a control signal. The main signal communication path 4 is a large-capacity and low-delay communication path of a layer 1 (lower layer). It is assumed that the control communication path 3 is always set and the main signal communication path 4 is dynamically set in response to a request from a user.

The computing machines 1 and 2 perform data transfer by remote direct memory access (RDMA) communication. The RDMA communication is communication for transferring data from a memory of one computing machine 1 to a memory of the other computing machine by direct memory access (DMA). In the RDMA communication, since data is transferred without passing through operating systems of the computing machines 1 and 2, the data transfer can be realized with high throughput and low latency.

In the embodiment, as an upper layer of the main signal communication path 4 (OTN protocol) of the layer 1, an RDMA communication path (RDMA protocol) is set on the main signal communication path 4 to the computing machines 1 and 2 in an end-to-end manner. That is, the communication system of the embodiment realizes transfer of RDMA over Layer 1.

Each of the computing machines 1 and 2 includes an RDMA communication unit 11 (communication unit), a communication switching unit 12, a data storage unit 13, an RDMA control unit 14 (control unit), a control signal transmitting/receiving unit 15, and a main signal transmitting/receiving unit 16.

The RDMA communication unit 11 is an application that performs RDMA communication. The RDMA communication unit 11 is installed by using a CPU and a memory. The RDMA communication unit 11 controls setting and cancelling of the main signal communication path 4. For example, the RDMA communication unit 11 of the computing machine 1 transmits setting information (control message) for setting the main signal communication path 4 to the computing machine 2 of the access destination via the control communication path 3.

The RDMA communication unit 11 controls setting and cancelling of the RDMA communication path. Specifically, the RDMA communication unit 11 of the computing machine 1 instructs the RDMA control unit 14 to set the RDMA communication path in parallel with the transmission of the setting information of the control communication path 3.

The communication switching unit 12 is, for example, a root complex, a PCI switch, or the like, and switches a communication destination device of the RDMA communication unit 11.

The data storage unit 13 is a memory, a storage, or the like, and stores various data. When the data storage unit 13 is a memory, the RDMA communication unit 11 operates on the data storage unit 13.

The RDMA control unit 14 controls data transfer by the RDMA communication. A direct memory access (DMA) controller can be used as the RDMA control unit 14. The DMA controller is a dedicated application (IC chip) that controls DMA transfer and is installed on, for example, a field programmable gate array network interface card (FPGA NIC). The RDMA control unit 14 of the present embodiment secures a memory area for the RDMA communication based on an instruction from the RDMA communication unit 11 and transmits setting information including the memory area to the computing machine 2 of the access destination via the control communication path 3 to set the RDMA communication path.

The control signal transmitting/receiving unit 15 transmits and receives a control signal flowing through the control communication path 3. A network interface card (NIC) can be used as the control signal transmitting/receiving unit 15.

The main signal transmitting/receiving unit 16 transmits and receives a main signal flowing through the main signal communication path 4. As the main signal transmitting/receiving unit 16, an NIC equipped with a laser or the like can be used. The main signal transmitting/receiving unit 16 establishes the main signal communication path 4 based on the setting information of the main signal communication path 4.

### Setting Process of Communication Path

Next, setting processes of the main signal communication path 4 and the RDMA communication path will be described. It is assumed that the control communication path 3 is set in advance. The setting processes of the main signal communication path 4 and the RDMA communication path include the following processes A, B, and C. The processes A and B and the process C can be performed in parallel.

Process A: The computing machines 1 and 2 that perform RDMA communication transmit and receive a control message (setting request and setting response) for setting the main signal communication path 4 via the control communication path 3.

Process B: The computing machines 1 and 2 set the main signal communication path 4 based on the control message.

Process C: The computing machines 1 and 2 transmit and receive a control message (setting request and setting response) for setting the RDMA communication path and set the RDMA communication path.

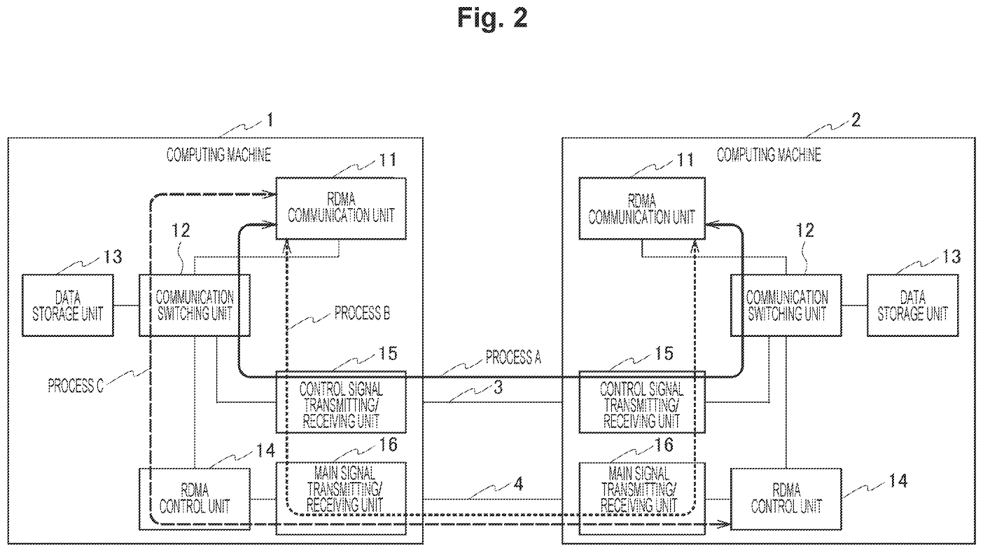

FIG. 2 is an explanatory diagram for explaining a setting process of a communication path in a comparative example of the embodiment. In FIG. 2, the main signal communication path 4 and the RDMA communication path are sequentially set in the order of the process A, the process B, and the process C. That is, the communication paths are established in order from a lower layer to an upper layer for each layer, and the setting of the RDMA communication path in the process C is not started until the main signal communication path 4 is established. In the comparative example, the process C is performed via the main signal communication path 4.

Therefore, the time until the RDMA communication path is established is the sum of the respective processing times of the process A, the process B, and the process C, and a long time is required from the start of the setting process to the start of the RDMA communication. A processing time of the process B is as long as several minutes.

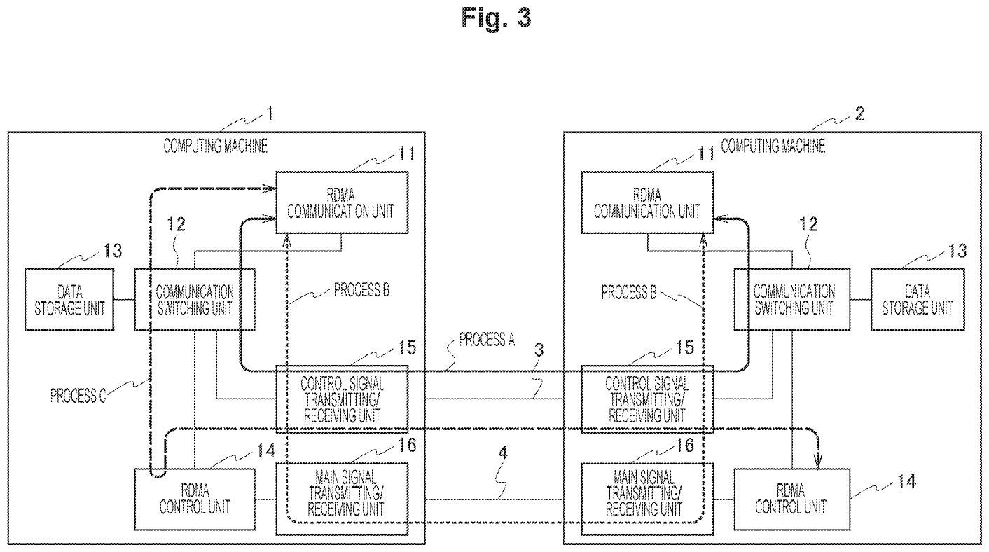

FIG. 3 is an explanatory diagram for explaining a setting process of a communication path according to the embodiment.

In the present embodiment, the processes A and B and the process C are performed in parallel. The control communication path 3 is used not only to set the main signal communication path 4 but also to set the RDMA communication path. The control communication path 3 is established in advance in order to set (or cancel) the main signal communication path 4.

The RDMA communication unit 11 starts setting of the main signal communication path 4 and also starts setting of the RDMA communication path. Consequently, in the present embodiment, the setting of the main signal communication path 4 and the setting of the RDMA communication path are processed in parallel, and the time from the start of the setting process to the start of the RDMA communication can be shortened.

As illustrated in FIG. 3, in the process A, the RDMA communication unit 11 of the computing machine 1 transmits and receives a control message (setting information) for setting the main signal communication path 4 to and from the RDMA communication unit 11 of the computing machine 2 of the access destination via the control signal transmitting/receiving unit 15 and the control communication path 3.

In process B performed after the process A, the RDMA communication unit 11 of the computing machine 1 controls the main signal transmitting/receiving unit 16 to establish the main signal communication path 4, in cooperation with the computing machine 2 of the access destination based on the control message.

The process C is independently performed in parallel with the process A and the process B. The RDMA communication unit 11 of the computing machine 1 sends a setting instruction of the RDMA communication path to the RDMA control unit 14. The RDMA communication unit 11 secures a memory area for RDMA communication based on the instruction and transmits setting information including the secured memory area to the computing machine 2 of the access destination via the control communication path 3. The RDMA control unit 14 of the computing machine 2 secures a memory area for RDMA communication based on the setting information. Consequently, the RDMA communication path is set.

In the present embodiment, since the process C is performed in parallel with the processes A and B, the time until the RDMA communication path is established is the sum of the respective processing times of the process A and the process B, and the time until the RDMA communication is started can be shortened compared with that in the comparative example of FIG. 2.

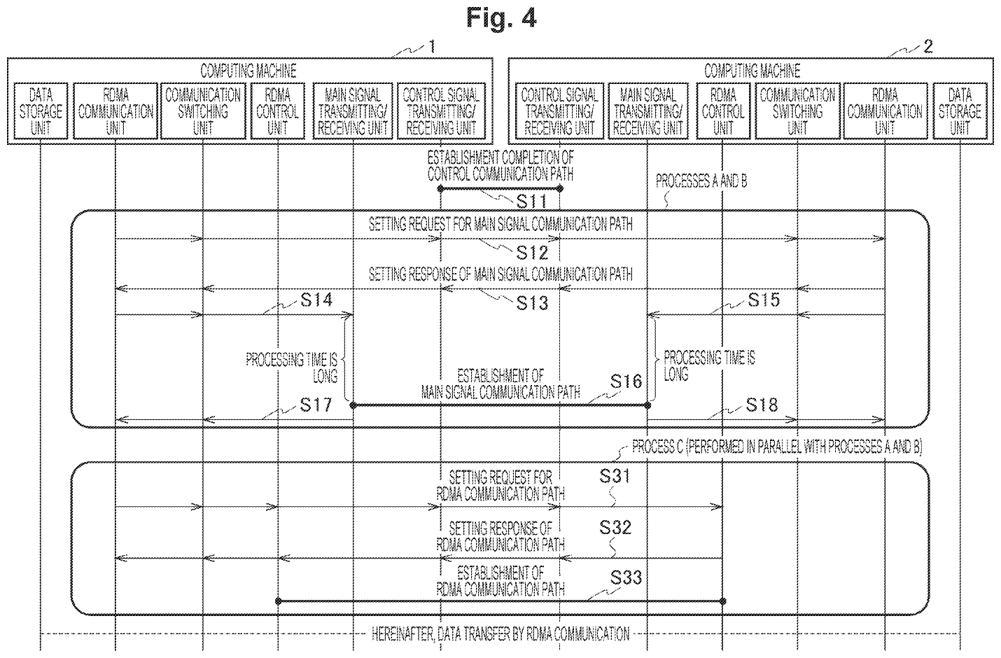

FIG. 4 is a sequence diagram illustrating a setting process of the communication path according to the embodiment in FIG. 3.

The process A is S12 and S13, the process B is S14 to S18, and the process C is S31 to S33. The control communication path 3 is established between the computing machines 1 and 2 in advance (S11).

In the process A, the RDMA communication unit 11 of the computing machine 1 receives a request of a user and transmits a setting request (control message) including the setting information for setting the main signal communication path 4 to the computing machine 2 via the control signal transmitting/receiving unit 15 and the control communication path 3 (S12). In the request of the user, a node identifier of the computing machine 2 of the access destination is designated.

The main signal communication path 4 (optical path) can be set or cancelled using distributed control such as generalized multi protocol label switching (GMPLS) (Non-Patent Literature 2) or centralized control such as software defined network (SDN) or network management system (NMS)/element management system (EMS) (Non-Patent Literature 3).

When the distributed control of GMPLS is used, the setting information (setting request) transmitted by the computing machine 1 includes a message identifier (session ID), a node identifier of a local end point of the main signal communication path 4, a node identifier of a remote end point of the main signal communication path 4, an adjacent hop/end point identifier, a wavelength label identifier (possibility group), a transfer capacity, or the like.

When the centralized control of the SDN is used, the setting information (setting request) transmitted from the computing machine 1 to the computing machine 2 via the centralized control server (not illustrated) includes a message identifier (session ID), a node identifier of a local end point of the main signal communication path 4, an interface/end point identifier as a local end point of the main signal communication path 4, a node identifier of a remote end point of the main signal communication path, a wavelength label identifier, a transfer capacity, or the like.

The RDMA communication unit 11 of the computing machine 2 receives the setting request via the control signal transmitting/receiving unit 15 and sets the main signal communication path 4 based on the setting information included in the setting request. The RDMA communication unit 11 of the computing machine 2 transmits a setting response (control message) including the setting information of the main signal communication path 4 to the computing machine 1 via the control signal transmitting/receiving unit 15 and the control communication path 3 (S13). The computing machine 1 receives the setting response via the control signal transmitting/receiving unit 15.

When the distributed control of the GMPLS is used, the setting information (setting response) transmitted by the computing machine 2 includes a message identifier (session ID), a node identifier of a local end point of the main signal communication path 4, a node identifier of a remote end point of the main signal communication path 4, an adjacent hop/end point identifier, a transfer capacity, an adjacent hop/end point identifier and a wavelength label identifier determined as the main signal communication path 4, or the like.

When the centralized control of the SDN is used, the setting information (setting response) transmitted to the computing machine 1 via the centralized control server includes a message identifier (session ID), a node identifier of a local end point of the main signal communication path 4, an interface/end point identifier as a local end point of the main signal communication path 4, a node identifier of a remote end point of the main signal communication path, a wavelength label identifier, a transfer capacity, or the like.

In the process B, when receiving the setting response, the RDMA communication unit 11 of the computing machine 1 instructs the main signal transmitting/receiving unit 16 to activate the main signal communication path 4 (S14). After transmitting the setting response, the RDMA communication unit 11 of the computing machine 2 instructs the main signal transmitting/receiving unit 16 to activate the main signal communication path 4 (S15). The main signal transmitting/receiving unit 16 of each of the computing machines 1 and 2 establishes the main signal communication path 4 based on the setting information of the setting request and the setting response (S16). A long time of about several minutes is required from when each of the main signal transmitting/receiving units 16 receives an activation instruction to when the main signal communication path 4 is actually established.

After establishing the main signal communication path 4, each of the main signal transmitting/receiving units 16 of the computing machines 1 and 2 sends a response to the activation instruction to the RDMA communication unit 11 (S17 and S18).

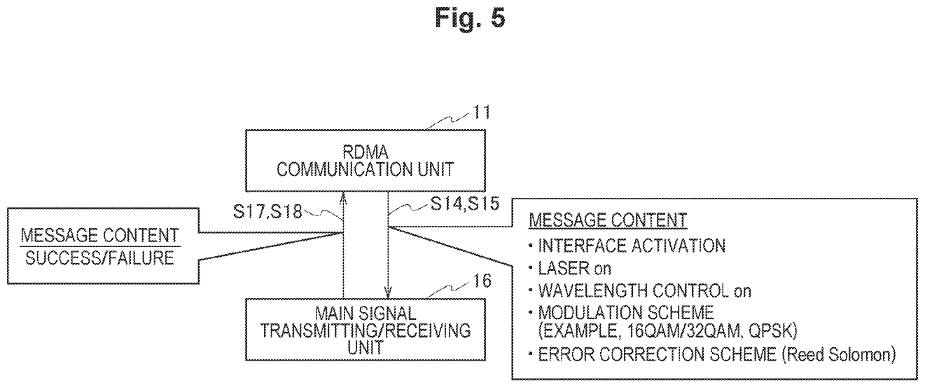

FIG. 5 is an explanatory diagram illustrating messages between the RDMA communication unit 11 and main signal transmitting/receiving unit 16 in S14 and S17 (or S15 and S18) in FIG. 4.

The RDMA communication unit 11 sends a message including the following items to the main signal transmitting/receiving unit 16 as an activation instruction in S14 and S15.
Interface activation
Laser on
Wavelength control on
Modulation scheme (example, 16QAM/32QAM, QPSK)
Error correction scheme (Reed Solomon)

Further, in the case of an instruction to stop the main signal communication path 4, the messages are “interface stop”, “laser off”, and “wavelength control off”.

As a response to S17 and S18, the main signal transmitting/receiving unit 16 sends a message indicating a processing result as to whether the establishment of the main signal communication path 4 has succeeded or failed.

Returning to FIG. 4, the process C will be described. The process C is executed in parallel with the process A and the process B. The RDMA communication unit 11 of the computing machine 1 sends a setting instruction of the RDMA communication path to the RDMA control unit 14. On the basis of the instruction, the RDMA control unit 14 performs setting such as securing a memory for RDMA and transmits a setting request including setting information to the computing machine 2 of the access destination via the control signal transmitting/receiving unit 15 and the control communication path 3 (S31).

Upon receiving the setting request via the control signal transmitting/receiving unit 15, the RDMA control unit 14 of the computing machine 2 performs setting such as securing a memory for RDMA on the basis of the setting information included in the setting request and transmits a setting response including the setting information to the computing machine 1 via the control signal transmitting/receiving unit 15 and the control communication path 3 (S32). Consequently, the RDMA communication path is set (S33).

Further, the RDMA communication unit 11 of the computing machine 1 may include a communication start timing in the setting information to be transmitted to the computing machine 2 in S31. Specifically, the RDMA communication unit 11 sets the communication start timing in a setting instruction to the RDMA control unit 14, and the RDMA control unit 14 transmits the setting information including the communication start timing to the computing machine 2. The RDMA communication units 11 of the computing machines 1 and 2 actually start the RDMA communication based on the communication start timing.

The communication start timing is timer information and may be, for example, an establishment time point of the RDMA communication path+a predetermined time (fixed value). The predetermined time is set reflecting the time required to establish the main signal communication path 4, and thereby the RDMA communication is started after the establishment of the main signal communication path 4.

When the RDMA communication path is established before the main signal communication path 4 is established and the RDMA communication is started, the RDMA communication fails. Therefore, the failure of the RDMA communication can be suppressed by setting the communication start timing in the setting information.

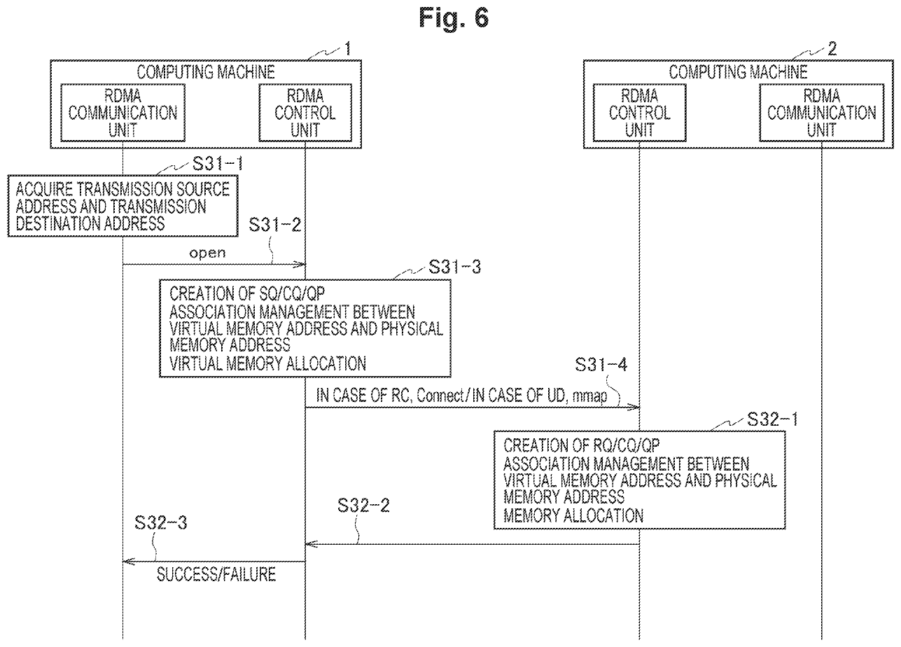

FIG. 6 is a sequence diagram illustrating details of processes of the RDMA communication unit 11 and the RDMA control unit 14 in S31 and S32 in FIG. 4.

The RDMA communication unit 11 of the computing machine 1 acquires a transmission source address and a transmission destination address (S31-1) and sends the setting instruction for setting the RDMA communication path to the RDMA control unit 14 (S31-2). The setting instruction (for example, “open”) includes the following instructions.
Creation of send queue (SQ), completion queue (CQ), and queue pair (QP)
Association between virtual memory address and physical memory address
Memory allocation

The RDMA control unit 14 performs setting such as securing a memory for RDMA in accordance with the setting instruction (S31-3). The RDMA control unit 14 transmits a setting request including setting information such as memory information to the computing machine 2 via the control communication path 3 (S31-4). As the setting request, for example, “Connect” is used when the service type is reliable connection (RC) and “mmap” is used when the service type is unreliable datagram (UD).

Upon receiving the setting request, the RDMA control unit 14 of the computing machine 2 performs setting such as securing a memory for RDMA in accordance with the setting request (S32-1). Specifically, the RDMA control unit 14 executes the following setting in order to start the RDMA communication.
Creation of receive queue (RQ), completion queue (CQ), and queue pair (QP)
Association between virtual memory address and physical memory address
Memory allocation

The RDMA control unit 14 transmits the setting response including the setting information such as memory information to the computing machine 1 via the control communication path 3 (S32-2). The RDMA control unit 14 of the computing machine 1 receives the setting information and notifies the RDMA communication unit 11 of the setting information (S32-3). The setting information also includes a status indicating whether or not the computing machine 2 has successfully set the RDMA communication path. Consequently, the RDMA communication path is set.

In the embodiment illustrated in FIG. 4, the process C is performed in parallel with the processes A and B. Therefore, the processing time of the process C is absorbed in the processing times of the processes A and B, and the time until the RDMA communication is started is the sum of the processing times of the process A and the process B.

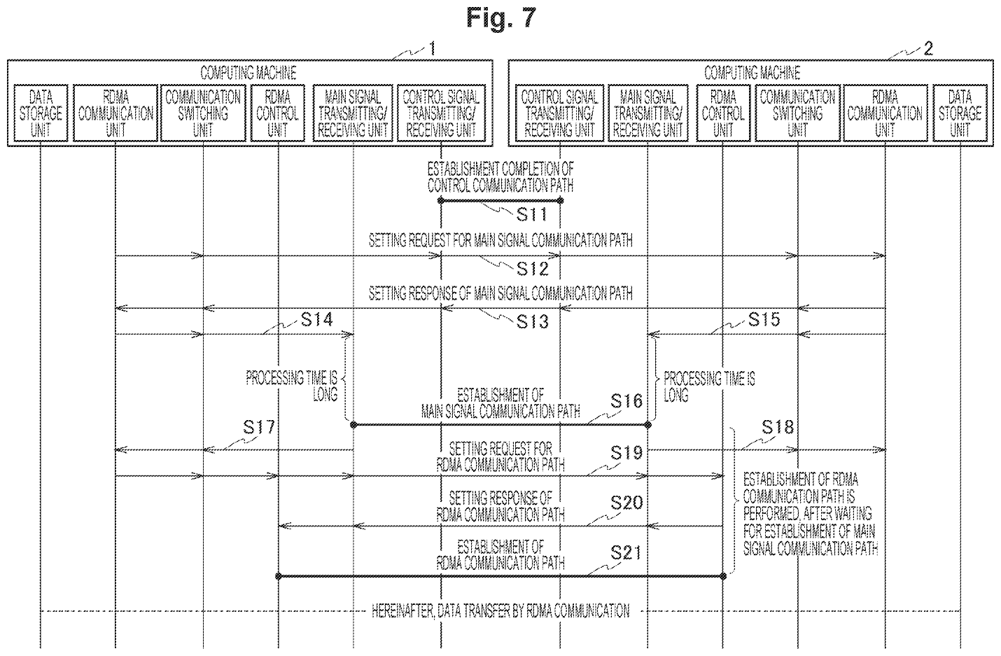

On the other hand, FIG. 7 is a sequence diagram illustrating a setting process of a communication path according to the comparative example illustrated in FIG. 2. In the illustrated sequence diagram, a setting request for setting the main signal communication path 4 is transmitted and received in S12 to S13 (process A), the main signal communication path 4 is set in S14 to S18 (process B), and the RDMA communication path is set in S19 to S21 (process C). That is, the main signal communication path 4 and the RDMA communication path are sequentially set in the order of the processes A, B, and C. Therefore, the time until the RDMA communication path is established is the sum of the respective processing times of the process A, the process B, and the process C, and is longer than that in the embodiment illustrated in FIG. 4.

### Operations and Effects

The communication system of the embodiment described above includes the plurality of computing machines connected to the optical network, in which the optical network includes the main signal communication path 4 and the control communication path 3, each of the computing machines 1 and 2 including the RDMA communication unit 11 that performs transmission of setting information for setting the main signal communication path 4 to the access destination computing machine via the control communication path 3, and the main signal transmitting/receiving unit 16 that establishes the main signal communication path 3 based on the setting information, in which the RDMA communication unit 11 gives an instruction for setting of the RDMA communication path in parallel with the transmission of the setting information, and the computing machine further includes the RDMA control unit 14 that secures the memory area for RDMA communication based on the instruction and transmits setting information including the memory area to the access destination computing machine via the control communication path 3 to set the RDMA communication path.

As described above, in the embodiment, the setting of the main signal communication path 4 and the setting of the RDMA communication path are performed in parallel. Consequently, in the embodiment, since the setting of the RDMA communication path can progress without waiting for the establishment of the main signal communication path of the layer 1 as in the communication scheme of the comparative example, the data communication of the RDMA can be started in a short time. That is, the time required to start the RDMA communication can be shortened.

In the present embodiment, the computing machine 1 may transmit the setting information including the communication start timing of the RDMA communication to the computing machine 2 of the access destination. Consequently, this makes it possible to avoid a situation in which the RDMA communication is started before the main signal communication path 4 is established.

### Hardware Configuration

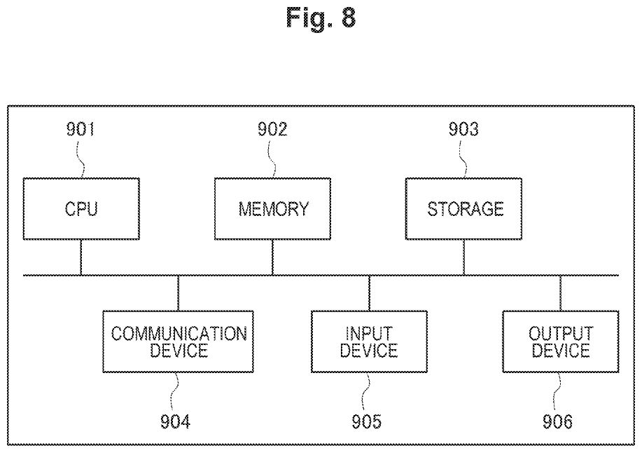

As the computing machines 1 and 2 described above, for example, a general-purpose computer system as illustrated in FIG. 8 can be used. The computer system illustrated in the drawing includes a central processing unit (CPU or processor) 901, a memory 902, a storage 903 (hard disk drive (HDD) or solid state drive (SSD)), a communication device 904, an input device 905, and an output device 906. The memory 902 and the storage 903 are storage devices. In the computer system, the CPU 901 executes a predetermined program loaded on the memory 902, and thereby functions of each of the computing machines 1 and 2 are realized.

In addition, the computing machines 1 and 2 may be implemented by one computer or may be implemented by a plurality of computers. In addition, the computing machines 1 and 2 may be a virtual machine that is implemented in a computer. The program for the computing machines can be stored in a computer-readable recording medium such as an HDD, an SSD, a Universal Serial Bus (USB) memory, a compact disc (CD), or a digital versatile disc (DVD), or can be distributed via a network.

Further, the present invention is not limited to the above embodiments, and various modifications can be made within the scope of the gist of the present invention.

### Reference Signs List

1, 2 Computing machine
11 RDMA communication unit (communication unit)
12 Communication switching unit
13 Data storage unit
14 RDMA control unit (control unit)
15 Control signal transmitting/receiving unit
16 Main signal transmitting/receiving unit
3 Control communication path
4 Main signal communication path

1. A communication system comprising a plurality of computing machines connected to an optical network,
wherein the optical network comprises a main signal communication path and a control communication path,
wherein each computing machine comprises
a communication unit configured to perform transmission of setting information for setting the main signal communication path to a computing machine of an access destination via the control communication path, and
a main signal transmitting/receiving unit configured to establish the main signal communication path based on the setting information,
wherein the communication unit is configured to give an instruction for setting of a remote direct memory access (RDMA) communication path in parallel with the transmission of the setting information, and
wherein the computing machine further includes a control unit configured to secure a memory area for RDMA communication based on the instruction and transmit setting information including the memory area to the computing machine of the access destination via the control communication path to set the RDMA communication path.

2. The communication system according to claim 1,
wherein the control unit is configured to transmit the setting information including a communication start timing of RDMA communication.

3. A computing machine connected to a computing machine of an access destination via an optical network,
wherein the optical network comprises a main signal communication path and a control communication path,
wherein the computing machine comprises
a communication unit configured to perform transmission of setting information for setting the main signal communication path to the computing machine of the access destination via the control communication path; and
a main signal transmitting/receiving unit configured to establish the main signal communication path based on the setting information,
wherein the communication unit is configured to give an instruction for setting of a remote direct memory access (RDMA) communication path in parallel with the transmission of the setting information, and
wherein the computing machine further comprises a control unit configured to secure a memory area for RDMA communication based on the instruction and transmit setting information including the memory area to the access destination computing machine via the control communication path to set the RDMA communication path.

4. A communication method performed by a communication system comprising a plurality of computing machines connected to an optical network,
wherein the optical network comprises a main signal communication path and a control communication path, and
wherein each computing machine is configured to perform
a step of transmitting setting information for setting the main signal communication path to a computing machine of an access destination via the control communication path,
a step of establishing the main signal communication path based on the setting information, and
a step of securing a memory area for remote direct memory access (RDMA) communication and transmitting setting information including the memory area to the access destination computing machine via the control communication path to set the RDMA communication path, in parallel with the step of transmitting the setting information.

5. A non-transitory computer-readable storage medium storing a program for causing a computer to function as the computing machine according to claim 3.
